(19) United States
(12) Patent Application Publication
(10) Pub. No.: US 2026/0081789 A1
(43) Pub. Date: Mar. 19, 2026

(54) PROVIDING CONTENT ORIGIN VERIFICATION

(71) Applicant: International Business Machines Corporation, Armonk, NY (US)

(72) Inventors: William James Simmons, Fareham (GB); Nicholas James Daffern, Truro (GB)

(21) Appl. No.: 19/041,921

(22) Filed: Jan. 30, 2025

(30) Foreign Application Priority Data
Sep. 18, 2024 (GB) 2413737.4

(51) Int. Cl. H04L 9/32

(52) U.S. Cl. CPC H04L 9/3263

(57) ABSTRACT

A computer-implemented method for content origin verification is provided. The computer-implemented method includes obtaining a signing certificate for a peripheral input device. The computer-implemented method further includes receiving input data from the peripheral input device and a digest associated with the input data. The computer-implemented method further includes processing the received input data as standard input. The computer-implemented method further includes verifying an origin of the standard input, in which the verifying includes applying the signing certificate for the peripheral input device to the digest and checking contents of the digest against the standard input.

### BACKGROUND

The present invention relates to content origin verification, and more specifically, to providing signed peripheral device input for content origin verification.

Artificially or maliciously generated content is prevalent, and validation of real content as assigned to a real human is important. Understanding the origin of a piece of typed content is becoming increasingly important. In many contexts, it is necessary to determine who authored a piece of content. For example, a post on social media, a piece of source code, or even a novel.

In the case of social media, users can create fake accounts imitating public figures and they can then create content which the public will perceive to be genuinely originating from the public figures.

In the case of source code, it can be difficult to prove whether source code was created or copied by a developer, and this may be critical during legal action over plagiarism between companies.

With the advance in generative Artificial Intelligence (AI), understanding the origin of a piece of typed content becomes even more important. There exist many offerings to help determine whether a piece of content was written by a human or AI. Most approaches try to analyze text to determine whether it displays the traits of a piece of content authored by AI. This does work in some cases but has limited accuracy and it is unclear how this will develop as generative AI increases in its sophistication.

### SUMMARY

The present invention seeks to provide one or more concepts for content origin verification. Such concepts may be computer-implemented. That is, such methods may be implemented in a computer infrastructure having computer executable code tangibly embodied on a computer readable storage medium having programming instructions configured to perform a proposed method. The present invention further seeks to provide a computer program product including computer program code for implementing the proposed concepts when executed on a processor.

According to one embodiment of the present invention, a computer-implemented method for content origin verification is provided. The computer-implemented method includes obtaining a signing certificate for a peripheral input device. The computer-implemented method further includes receiving input data from the peripheral input device and a digest associated with the input data. The computer-implemented method further includes processing the received input data as standard input. The computer-implemented method further includes verifying an origin of the standard input, in which the verifying includes applying the signing certificate for the peripheral input device to the digest and checking contents of the digest against the standard input.

According to another embodiment of the present invention, a computer program product for content origin verification is provided. The computer program product includes one or more computer-readable storage media and program instructions stored on the one or more computer-readable storage media to perform operations including: receiving input data from the peripheral input device and a digest associated with the input data, receiving input data from the peripheral input device and a digest associated with the input data, processing the received input data as standard input, and verifying an origin of the standard input. The operation to verify the origin of the standard input further includes applying the signing certificate for the peripheral input device to the digest and checking contents of the digest against the standard input.

According to yet another embodiment of the present invention, a computer system for content origin verification is provided. The computer system includes a processor set, one or more computer-readable storage media, and program instructions stored on the one or more computer-readable storage media to cause the processor set to perform operations comprising: receiving input data from the peripheral input device and a digest associated with the input data, receiving input data from the peripheral input device and a digest associated with the input data, processing the received input data as standard input, and verifying an origin of the standard input. The operation to verify the origin of the standard input further includes applying the signing certificate for the peripheral input device to the digest and checking contents of the digest against the standard input.

### BRIEF DESCRIPTION OF THE DRAWINGS

Embodiments of the present invention will now be described, by way of example only, with reference to the accompanying drawings:

FIG. 1 is a schematic diagram of an example embodiment of a system in accordance with aspects of the present invention.

FIG. 2 is a swim-lane flow diagram of an example embodiment of a method in accordance with aspects of the present invention.

FIG. 3A is a flow diagram of an example embodiment of a method performed by a peripheral input device in accordance with aspects of the present invention.

FIG. 3B is a flow diagram of an example embodiment of a method performed by an input receiving device in accordance with aspects of the present invention.

FIG. 3C is a flow diagram of an example embodiment of a method performed by a content accessing application in accordance with aspects of the present invention.

FIG. 4 is a block diagram of an example embodiment of a system including a peripheral input device and an input receiving device in accordance with aspects of the present invention.

FIG. 5 is a block diagram of an example computing environment for the execution of at least some of the computer code involved in performing aspects of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

Embodiments of methods, systems, and computer program products are described for providing signed peripheral device input for content origin verification.

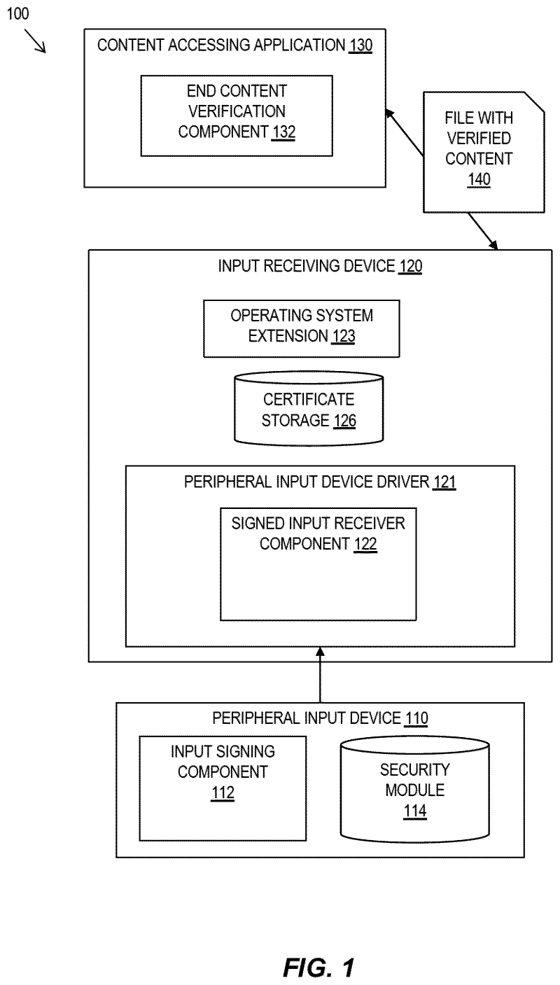

Referring to FIG. 1, an example embodiment of a system 100 is shown in which a peripheral input device 110 is used to transmit input data to an input receiving device 120. The peripheral input device 110 may be a keyboard with the input data being characters input by keystrokes of the keyboard. The keyboard may be a virtual keyboard or a physical keyboard. Other peripheral input devices may be used including pointing devices, such as computer mice or trackpads.

The peripheral input device 110 includes a security module 114 for signing with a signing certificate. For example, security module 114 may use a public certificate/private key signing protocol or other suitable centrally verifiable signing protocol. The peripheral input device 110 includes an input signing component 112 providing the functionality described further below for providing content origin verification by signing input data originating at the peripheral input device 110 for subsequent verification.

The system 100 includes an input receiving device 120 having a peripheral input device driver 121 for receiving input data from the peripheral input device 110. For example, the input receiving device 120 may be a computing system having an attached, integrated, or wirelessly communicating peripheral input device 110. The peripheral input device driver 121 may include a signed input receiver component 122 for providing the described functionality at the receiver for content origin verification. The input receiving device 120 may include an operating system extension 123 for processing the verification of the received input in association with the signed input receiver component 122. The input receiving device 120 may include or access a certificate storage 126 for verifying the received signed inputs.

The system 100 may also include a content accessing application 130 that may be local to the input receiving device 120. The content accessing application 130 may receive a file 140 having verified content as provided by the input receiving device 120 and the content accessing application 130 may include an end content verification component 132 for verifying the origin of the content. The content accessing application 130 may verify that content was typed by a given keyboard. This may be combined with other metrics to determine more accurately whether the content was generated by artificial intelligence.

The content origin verification is an improvement in the technical field of content security and verification. More particularly this relates to the technical field of peripheral input devices and processing their input.

The following definitions may aid in the interpretation of the description.

A peripheral input device is an auxiliary hardware or software device that an information processing system uses to receive information such as text, characters, or command input.

A hash is a unique identifier or signature generated by a cryptographic algorithm that is applied to data in a computing system. It serves as a digital fingerprint, allowing for the verification and validation of the integrity of data. A digest is a representation of a message computed by a cryptographic hash algorithm.

A scan code is the input data that computer keyboards and mice send to a computer system to report which keys have been pressed or inputs received from a mouse. A number, or sequence of numbers, is assigned to each key on the keyboard. With a physical keyboard, the keyboard hardware itself can send a scan code that can be translated to an actual keycode at the kernel level through a simple lookup. With a touchscreen, the hardware device is sending an X/Y position (along with some other data), which is then translated into a scan code by a previously exported virtual key map file.

A security module may be a hardware security module (HSM) in the form of a hardware device which signs data with a signature generated using a hardware private key.

An Interrupt Handler Routine (IHR) is a software process called by the hardware of the receiving computing system based on a particular interrupt.

The described methods and systems introduce a secure signing to a peripheral input device which shows that a piece of content was produced by a particular input device.

Each or a group of input data has a signed digest created and associated with the input that is sent via the data line. The signing value is unknown to even the owner of the peripheral and cannot be tampered with. The signing may use a hardware hashing module and software to produce a signed and verifiable digest associated with a given input from the peripheral input device.

The secure signing may use a HSM with a private key and a public certificate registered with a central certification authority. The digest may be signed with the private hardware key and a public key may be provided in a public certificate. The digest may be provided with each input data or set of input data, to a receiving device.

The described methods and systems further provide functionality to confirm within an application that content was generated using a specific peripheral input device. This may include using a software routine to process and validate the authenticity and origin of a content input, where the authenticity is validated by the digest and certificate cryptographic data associated with a given peripheral input device.

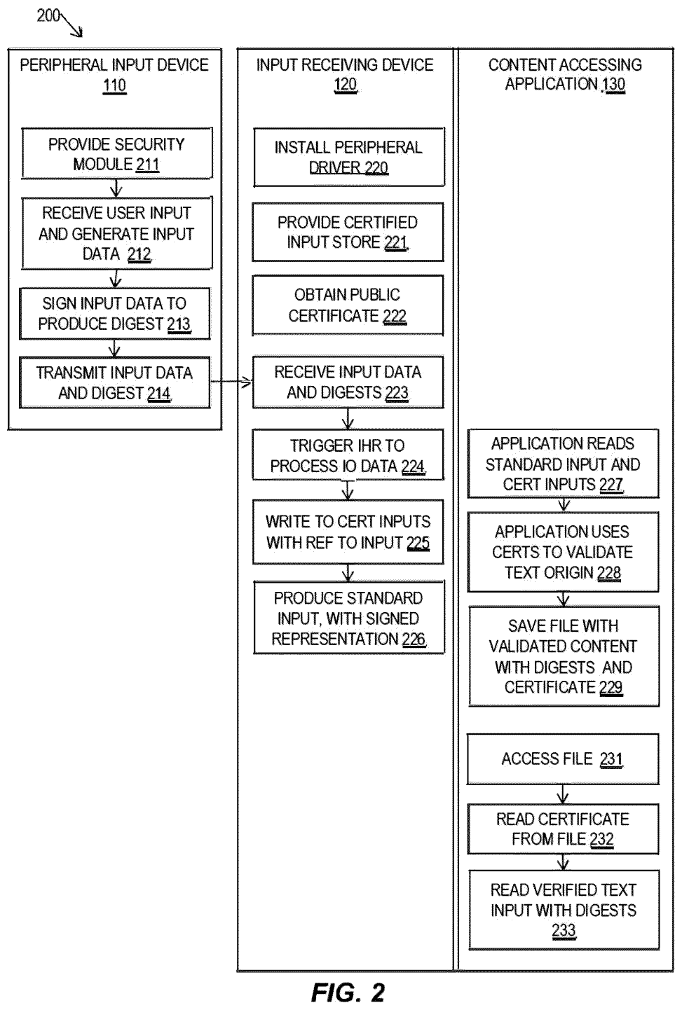

Referring to FIG. 2, a swim-lane flow diagram 200 shows an example embodiment of the described methods as carried out at a peripheral input device 110, an input receiving device 120, and a content accessing application 130.

The method may provide 211 a security module at the peripheral input device 110. The method receives 212 a user input at the peripheral input device 110 by a user and generates input data for the user input. For example, the user input may be one or more keystrokes from a keyboard, or an input command from a mouse.

The method signs 213 the received input data using the security module to produce a digest. The method transmits 214 the digest in association with the transmitted input data to an input receiving device 120 for verification of the origin of the input being the peripheral input device 110 by using the digest in association with the input data.

The security module may provide a private key and public certificate for the peripheral input device and signing 113 the input data to produce the digest may include signing the input data with the private key with the public certificate being available to the input receiving device 120.

In an embodiment where the peripheral input device is a keyboard and the input is one or more keystrokes, the method includes generating a scan code for a keystroke, copying one or more scan codes, adding a salt, and signing the salted one or more scan codes to produce the digest.

Various embodiment for transmitting 214 the digest in association with the transmitted input data to an input receiving device 120 are envisioned and described in more detail below. The transmitting may include serializing and storing the digest on a data line for receiving by the input receiving device 120 in association with the input data.

Transmitting the digest may include combining two or more digests and condensing a combined digest for transmission. Some input information may be provided without an in-line digest, and the method may provide an additional digest for this input information. A master digest may be provided of all input information in a piece of content. The method may use a data reducing schema to reduce a data transmission rate of the digests. For example, a Merkle tree schema and low overhead signature schemes may be used for reducing of the data transmission rate.

Transmitting the digest may be carried out in response to an input prompt, such as a specific keystroke, or in response to a defined input interval, such as a number of keystrokes.

The method carried out at an input receiving device 120 having a connected peripheral input device 110 may include installing 220 a peripheral input device driver. The input receiving device 120 may have 221 a certified input storage. The standard certification input may be a file location known to the operating system containing digests for data written to the standard input. The input receiving device 120 obtains 222 a signing certificate for the peripheral input device 110.

The method at the input receiving device 120 may include receiving 223 input data from the peripheral input device 110 in combination with a digest for the input.

The method may process the received input data as a standard input. This may trigger 224 an interrupt handler routine that writes 225 digests to a standard certification input associated with the standard input. The standard input may be processed as usual by reading the received input to obtain the input character and writing as a standard input.

The method may produce 226 a standard input with a signed representation by storing the digest in association with the standard input for verification of the origin of the standard input by applying the signing certificate of the peripheral input device to the digest and checking the digest content with the standard input.

A further aspect of the method may be carried out by a content accessing application 130 at the input receiving device 120.

The method may read 227 one or more sets of input data from standard input and make a parallel check to the standard certification input for the associated digests. The method may use 228 the signing certificate to verify the origin of the digest and therefore the input data.

Verifying the digest may include: decrypting the digest with the signing certificate; discarding a salt included in the digest; and checking the standard input against the digest.

A file including the verified content may be saved 229 and represented in a user interface as having origin verified inputs. Saving 229 a file with origin verified inputs may save a copy of the associated digests and a copy of the signing certificate. The file may be exported to other devices.

The file or sections of the file may have text copied and pasted text with the verified origin included with the text.

An application accessing 231 the file may read 232 the signing certificate from the file and may verify 233 the text input data with the digests. The verification may be executed by a program, interface, or application as part of displaying, processing, or manipulating the file.

Using extensions to standard operating system methods which follow similar principles to current practices reduces the complexity of adoption of the verification for current applications. The method may include executing software routines by a program, interface, or application as part of displaying, processing, or manipulating the signed text.

Text produced by a keyboard owned by a known individual allows for the validation of origin and authenticity of text. The solution leverages cryptography and changes to operating system behavior to allow validation of keystrokes from a given keyboard.

The solution integrates with existing applications and software such that applications which do not support signed text will not be affected by the use of a keyboard which supports this functionality. This may be achieved by using extensions to standard operating system methods which follow similar principles to current practices, which reduces the complexity of adoption for current applications.

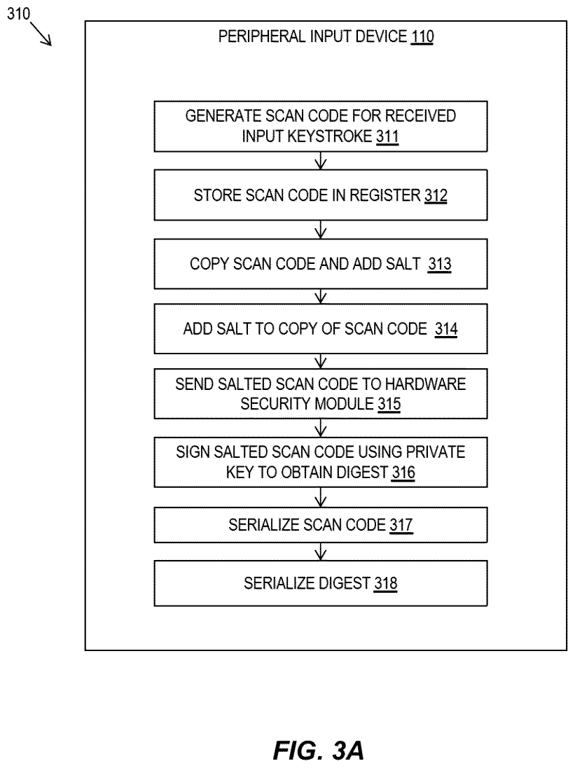

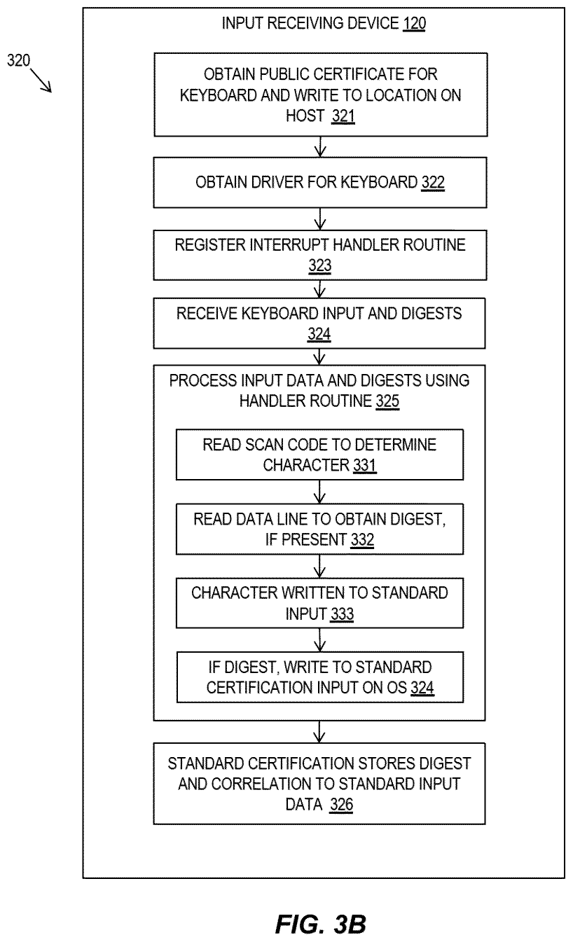

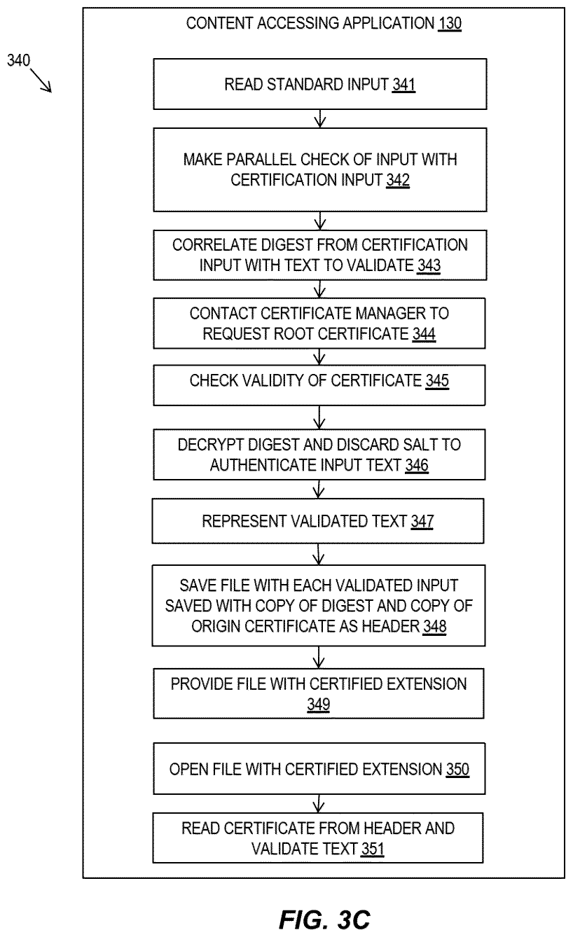

Referring to FIG. 3A, a flow diagram 310 shows an example embodiment of an aspect of the described method as carried out at the peripheral input device 110. In this embodiment, the peripheral input device 110 is a physical keyboard having a set of physical keys. These keys interact with one of an array of standard key switching devices (i.e. mechanical, membrane, etc.) in order to output a high signal. The switching devices are connected to a processing unit that converts the signal from the switching device into a scan code.

In addition to a conventional keyboard, the described keyboard is provided with a hardware security module (HSM) storing a private key unique to the keyboard and a shareable public key certificate. The public key certificate is signed by the keyboard manufacturer at manufacture time and so can be validated by the manufacturers root certificate. (i.e. KeyboardWorld Root CA). Optionally, this module can be remotely programmable in order to allow custom certificates, or certificate rotation.

At the time of a keyboard input, the described method is carried out at a processing unit of the keyboard. The method generates 311 the scan code for received input keystrokes. The method stores 312 the scan code in a register.

The keyboard may optionally have a switch which will enable or disable sending verifiable key presses. On disabling of this mode, when a key is pressed the scan code is simply serialized and sent to the connected device. When the mode is enabled, the following method is carried out.

The method copies 313 the scan code to a salt component where the method adds 314 “salt” to the scan code. The salt may be a series of random additional scan codes or other form of random data.

The method sends 315 the salted scan code to the hardware security module on the keyboard circuit board to sign 316 the salted scan code to produce a digest for the key press using the private key of the keyboard.

The method serializes 317 the scan code to be sent by a communication module of the keyboard. The method serializes 318 the digest and this is stored on the data line so it can be read by the receiving operating system.

The method may send digests for each keystroke or for a group of keystrokes. Furthermore, the digests may be sent individually or combined. A combined digest approach may reduce the data rate, for example, using Merkle schemes or low overhead signature schemes. The keyboard may choose to use a Merkle scheme to combine digests for each character and send a periodic Merkle Hash. This allows the data rate from keyboard to device to be reduced.

The method may send digests at intervals and while the scan codes are being sent, the method may compute a master hash of all scan codes that have been sent without a digest or an over-arching master hash.

The digests may be generated when the user presses a defined character (for example, the spacebar or enter or a punctuation mark) or after a set number of characters have been entered. The computed group hash may be sent to the receiving device along with an indication that it is the hash.

Referring to FIG. 3B, a flow diagram 320 shows an example embodiment of an aspect of the described method as carried out at an input receiving device 120 where a receiving operating system processes the incoming data from the keyboard as sent according to FIG. 3A.

The keyboard of FIG. 3A may be connected to a device running a host operating system. The keyboard may communicate its Universal Serial Bus (USB) type to the host which is that of a verifiable keyboard.

The method at the input receiving device 120 obtains 321 the public certificate for the keyboard and writes this to a location on the input receiving device 120. The keyboard may provide the public certificate representing this specific keyboard via the USB type or by storing the certificate on the data line. This certificate is written to a new standard location on the host operating system, i.e., STD_IO_CERT.

The method obtains 322 and installs a driver for the keyboard on the operating system if one is not already available.

The driver registers 323 or overwrites an interrupt handler routine (IHR) for IRQX (Interrupt Request), where X is a number. The operation of the IHR that is added or replaced is described further below.

The method receives 324 the data including the keyboard inputs and digests from the keyboard and the operating system processes 325 this data using the IRQX request as a signed keyboard interrupt handler routine for a new standard certification input.

The scan code is read 331 to determine the character. The data line is read 332 from the keyboard controller to obtain the digest for the character (callback). The character is written 333 to a standard input. The digest is written 324 to a standard certification input as defined below. If a digest is not present on the data line, then the IHR handles the character as a standard unsigned character.

The standard certification input is a file location known to the operating system that stores 326 the “signing information” (digest) for the data being written to a standard input by the Interrupt Handler Routine. Optionally, standard certification input can also include the data being written to the Standard Input, so that programs reading from this file can easily correlate the Standard Input data with the standard certification input data.

Referring to FIG. 3C, a flow diagram 340 shows an example embodiment of an aspect of the described method as carried out at a content accessing application 130 at the input receiving device 120 of FIG. 3B.

The application reads 341 a character from standard input as normal. The application makes 342 a parallel check to the standard certification input. If the digest from the standard certification input can be correlated 343 with the text from the standard input, then the application accepts that the digest is the certification for the text/character input.

Periodically, the application may make contact 344 with the local certificate manager (store) on the operating system and request copies of keyboard provider/manufacturer root certificates (i.e., KeyboardWorld Root CA). The application may read the certificate located at STD_IO_CERT and check its validity 345 using the keyboard provider root certificates.

If the certificate is valid, then each character's authenticity may be validated by decrypting 346 the digest with this certificate and discarding the appended salt.

When a character is validated, the application may represent 347 the validated text differently in a user interface.

When a file is saved 348, each validated character may be saved to file with a copy of its digest and a single copy of the keyboard certificate (and/or keyboard provider root certificate), for example, as a header. This file may be provided 349 with a new extension, for example,. txtc.

When a file with a certified extension is opened 350, the certificates may be read 351 from the top of the file. Each character may be validated using these certificates and the digests associated with the characters.

A file may contain multiple different individual keyboard certificates as well as associated root certificates. This allows text to be validated that has been typed by several different keyboards.

When using a signed device or interacting with signed text in a given content accessing application, the functionality of various keyboard shortcuts may be modified. As an example, the copy and paste shortcuts are described.

A user copies a section of signed text and a clipboard on the operating system now contains both the certificate for that signed text, optionally, its root certificate, and the text itself, as well as corresponding digests. When the user pastes the text to a new location, it is written as signed text (text and digest) and the original certificate and, optionally, root certificate are preserved in the file.

User interface features may be provided for representing signed text. Some examples of how signed text may be processed to be displayed in a user interface or to modify program function are listed below.

A verified icon may be provided if the text is signed, for example, next to the text, in a text box, or on the user interface of a website or application.

A known user associated with a peripheral input device or certificate may be provided, for example, using email, name, etc. or keyboard manufacturing details. This may be provided as text, a hover-over, etc.

A hyperlink may be created to a user's profile who is known to be associated with the certificate for the text. Alternatively, a button may be created that links to the creator's profile on the site where the text is posted.

Text may be removed or highlighted if it is unsigned. The highlighting may be in a color, changing its opacity, changing its font, etc. A warning icon may be provided if a user has written text that is unsigned.

For text that has been copied and pasted, the user interface may display the original author, a color or opacity based on aforementioned information, etc.

On saving text or submitting text in a form, etc., an application may carry out one or more of the following: refuse to save the file if text is copied or unsigned (or refuse to submit a form), present a warning to the user, email the original author of the text if their email address is known, and file an entry on a public database.

The use of a keyboard manufacturer certification authority (CA) is not essential for the method to have value but does increase the usability. Instead of using a CA, in the case of a dispute about the origin of some text, the origin may be proved by using the private key of a keyboard that the text originated from this keyboard. For example, to prove in a dispute over the origin of source code, the private key of a developer's keyboard may be used to prove that the signed text was produced by the keyboard.

The described functionality may be provided as part of an artificial intelligence (AI) detection offering. The signed input allows easier detection of when an author has, copy-pasted code or text either from another users'work, from a generative AI tool or some other location.

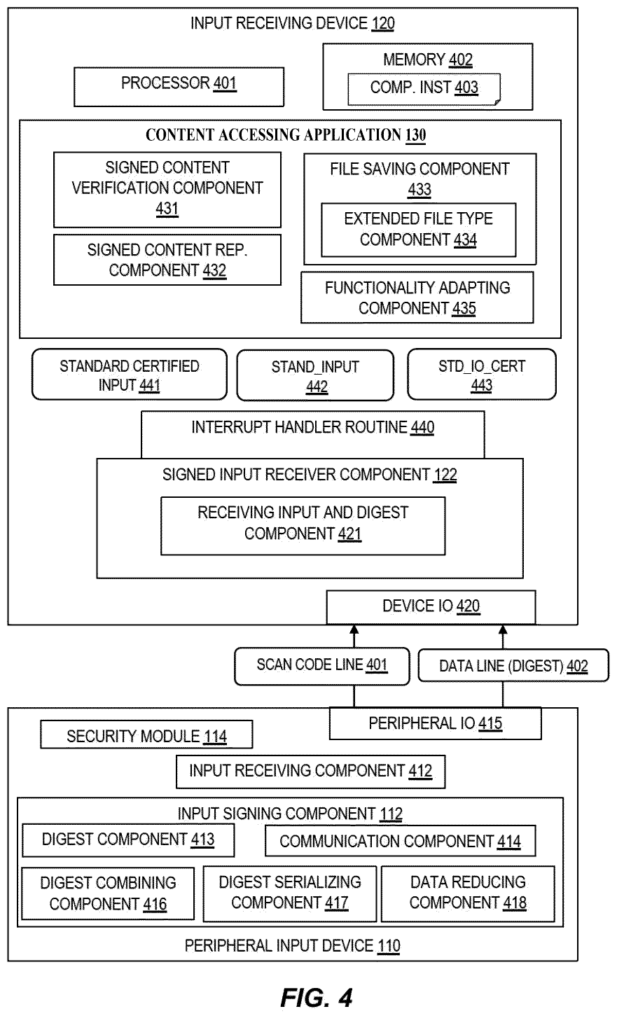

Referring to FIG. 4, a block diagram shows an example embodiment of a peripheral input device 110 and an input receiving device 120. The input receiving device 120 may be in the form of a computing system including at least one processor 401, a hardware module, or a circuit for executing the functions of the described components which may be software units executing on the at least one processor. Multiple processors running parallel processing threads may be provided enabling parallel processing of some or all of the functions of the components. Memory 402 may be configured to provide computer instructions 403 to the at least one processor 401 to carry out the functionality of the components.

The peripheral input device 110 includes a processor and computing functionality for processing the text signing by executing an input signing component 112.

The peripheral input device 110 has a security module 114 that may be provided on a circuit board of the peripheral input device 110. The peripheral input device 110 includes an input receiving component 412 for receiving an input by a user, for example, this may be a keypress component of a peripheral input device 110 in the form of a keyboard.

The peripheral input device 110 includes the input signing component 112 including a digest component 413 for signing the received input data using the security module 411 to produce a digest. The input signing component 112 includes a communication component 414 for transmitting the digest in association with the transmitted input data to the input receiving device 120. The communication component 414 may use the peripheral Input/Output (IO) 415 that communicates with the device IO 420 of the input receiving device 120.

The input signing component 112 may include a digest combining component 416 for combining two or more digests and transmitting a combined digest. The input signing component 112 may include a digest serializing component 417 for serializing and storing the digest on a data line for receipt by the input receiving device 120 in association with the input data.

The input signing component 112 may include a data reducing component 418 for using a data reducing schema to reduce a data transmission rate of the digests.

The input receiving device 120 includes a signed input receiver component 122 for receiving the signed input from a connected peripheral input device 110.

The signed input receiver component 122 may obtain a signing certificate for the peripheral input device 110 and may store this in a certificate store “Standard_IO_Certificate” 443.

The signed input receiver component 122 may include an input and digest receiving component 421 for receiving input data from the peripheral input device 110 in combination with a digest for the input data. The input data may be scan codes of keystrokes.

The signed input receiver component 122 may include an interrupt handler routine 440 for processing the received input data as a standard input and an associated digest by applying an interrupt handler routine. Applying the interrupt handler routine may include intercepting received input data and the associated digest, reading the received input data to obtain the input character and writing as a standard input “Standard_Input” 442, and writing the received digest to a standard certification input 441 associated with the standard input.

The standard certification input 441 may be at a file location known to the OS containing digest for data written to the standard input 442.

The input receiving device 120 includes a content accessing application 130 including a signed content verification component 431 for reading input data from standard input, making a parallel check to the standard certification input for the associated digest, and verifying the digest by verifying the signing certificate.

The content accessing application 130 may include a signed content representation component 432 for representing origin verified inputs in a user interface of the input receiving device 120.

The content accessing application 130 may include a file saving component 433 for saving a file with origin verified inputs with a copy of the associated digests and a copy of the signing certificate. The file saving component 433 may include an extended file type component 434 for providing a file extension indicating the signed file type.

The content accessing application 130 may include a functionality adapting component 435 that limits or extends program functionality based on if text is signed or not, for example, preventing clicking a ‘submit’ button if text is not signed.

In the embodiments described in FIGS. 3A to 3C, the peripheral input device 110 is a keyboard that has a salt module, a HSM for signing, a serialization module, and a module for controlling communication. The HSM may be provided on the keyboard's circuit board. Keystrokes from the keyboard are signed using a private key of the keyboard.

The input receiving device 120 receives the scan codes of the keystrokes and digests and triggers an IHR to process the IO data. The IO data is written to Standard Certified Input, Stand_Input and Standard_IO_Certificate.

The content accessing application 130 reads from Standard Certified Input, Stand_Input and Standard_IO_Certificate, and uses the accessed inputs and certificate to validate signed text.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

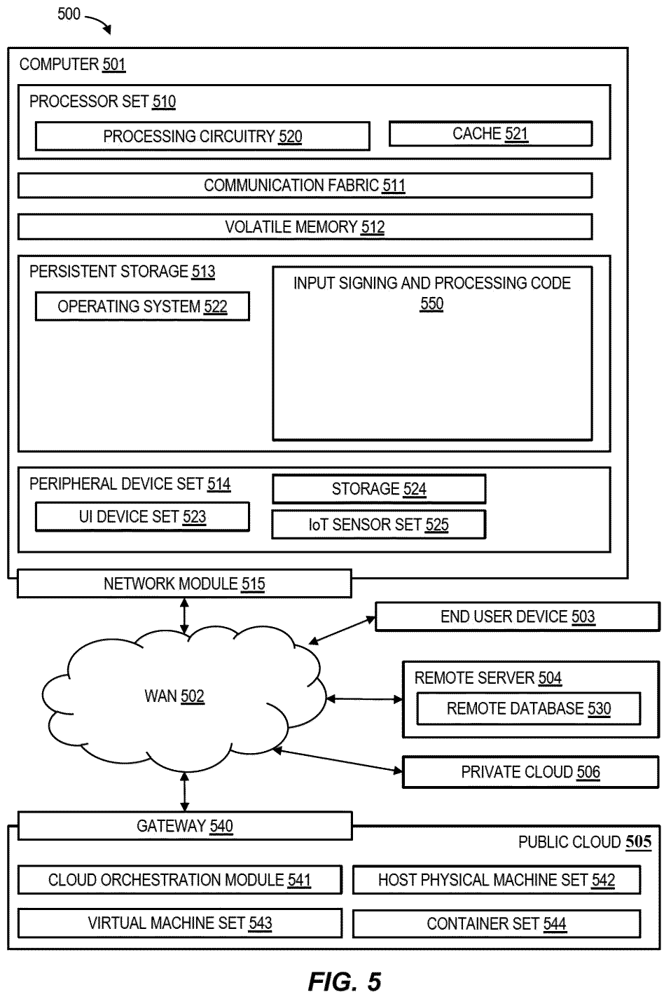

Referring to FIG. 5, computing environment 500 contains an example of an environment for the execution of at least some of the computer code involved in performing the inventive methods, such as input signing and processing code 550 for providing the functionality disclosed herein.

In addition to block 550, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 550, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 550 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 550 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

Aspects of the invention are defined in the attached claims. According to an aspect of the present invention there is provided a computer-implemented method for providing content origin verification, said method carried out at an input receiving device having a connected peripheral input device, comprising: obtaining a signing certificate for the peripheral input device; receiving input data from the peripheral input device in combination with a digest for the input data; processing the received input data as a peripheral device standard input; and storing the digest in association with the standard input for verification of the origin of the standard input by applying the signing certificate of the peripheral input device to the digest and checking the digest content with the standard input.

According to an aspect of the present invention there is provided a computer-implemented method for providing content origin verification, said method carried out at a peripheral input device having a security module, the method comprising: receiving a user input at the peripheral input device; generating input data for the user input; signing the input data using the security module to produce a digest; and transmitting the digest in association with the input data to an input receiving device for verification of the origin of the input data being the peripheral input device by using the digest in association with the input data.

According to a further aspect of the present invention there is provided a system for providing content origin verification, comprising a peripheral input device having a security module, the peripheral device including: a processor and a memory configured to provide computer program instructions to the processor to execute a method of: receiving a user input at the peripheral input device; generating input data for the user input; signing the input data using the security module to produce a digest; and transmitting the digest in association with the input data to an input receiving device for verification of the origin of the input data being the peripheral input device by using the digest in association with the input data.

According to a further aspect of the present invention there is provided a system for providing content origin verification, comprising an input receiving device having a connected peripheral input device, the input receiving device including: a processor and a memory configured to provide computer program instructions to the processor to execute a method of: obtaining a signing certificate for the peripheral input device; receiving input data from the peripheral input device in combination with a digest for the input data; processing the input data as a peripheral device standard input; and storing the digest in association with the standard input for verification of the origin of the standard input by applying the signing certificate of the peripheral input device to the digest and checking the digest content with the standard input.

According to a further aspect of the present invention there is provided a computer program product for providing content origin verification, the computer program product comprising a computer readable storage medium having program instructions embodied therewith, the program instructions executable by a processor to cause the processor to: receive a user input at the peripheral input device; generate input data for the user input; sign the input data using the security module to produce a digest; and transmit the digest in association with the input data to an input receiving device for verification of the origin of the input data being the peripheral input device by using the digest in association with the input data.

According to a further aspect of the present invention there is provided a computer program product for providing content origin verification, the computer program product comprising a computer readable storage medium having program instructions embodied therewith, the program instructions executable by a processor to cause the processor to: obtain a signing certificate for the peripheral input device; receive input data from the peripheral input device in combination with a digest for the input data; process the received input data as a peripheral device standard input; and store the digest in association with the standard input for verification of the origin of the standard input by applying the signing certificate of the peripheral input device to the digest and checking the digest content with the standard input.

What is claimed is:

1. A computer-implemented method for content origin verification, comprising:
obtaining a signing certificate for a peripheral input device;
receiving input data from the peripheral input device and a digest associated with the input data;
processing the received input data as standard input; and
verifying an origin of the standard input, the verifying including applying the signing certificate for the peripheral input device to the digest and checking contents of the digest against the standard input.

2. The computer-implemented method of claim 1, wherein receiving the digest associated with the input data includes applying a data reducing schema to the digest to reduce a data transmission rate of the digest from the peripheral input device to an input receiving device connected to the peripheral input device.

3. The computer-implemented method of claim 1, wherein a portion of the input data is received from the peripheral input device without an in-line digest, and wherein an additional digest for the portion of the input data without the in-line digest is received from the peripheral input device.

4. The computer-implemented method of claim 1, wherein the digest is received from the peripheral input device in response to an input prompt or a defined input interval of user input entered via the peripheral input device.

5. The computer-implemented method of claim 1, wherein the input data is generated based on user input entered via the peripheral input device.

6. The computer-implemented method of claim 5, wherein the peripheral input device is a keyboard and the user input is one or more keystrokes, and wherein the digest associated with the input data is produced based, at least in part, on:
generating a scan code for a keystroke;
copying the scan code;
adding a salt to the copy of the scan code; and
signing the salted copy of the scan code to produce the digest.

7. The computer-implemented method of claim 1, wherein signing the input data to produce the digest associated with the input data includes signing the input data with a private key with a public certificate for the peripheral input device.

8. The computer-implemented method of claim 1, wherein processing the received input data as the standard input includes applying an interrupt handler routine, the interrupt handler routine including:
reading the received input data to obtain one or more input characters;
writing the one or more input characters as the standard input; and
writing the digest to a standard certification input associated with the standard input.

9. The computer-implemented method of claim 8, wherein verifying the origin of the standard input further includes:
decrypting the digest with the signing certificate;
discarding a salt included in the digest to desalt the digest; and
checking the standard input against the decrypted and desalted digest.

10. The computer-implemented method of claim 1, further comprising:
representing verified origins of the standard input in a user interface of an input receiving device connected to the peripheral input device.

11. The computer-implemented method of claim 1, further comprising:
saving a file with verified origins of the standard input with a copy of the associated digests and a copy of the signing certificate.

12. The computer-implemented method of claim 11, further comprising:
executing a verification of the origin of contents included in the file by at least one of a program, an interface, or an application as part of displaying, processing, or manipulating the file.

13. A computer program product for content origin verification, comprising:
one or more computer-readable storage media;
program instructions stored on the one or more computer-readable storage media to perform operations comprising:
obtaining a signing certificate for a peripheral input device;
receiving input data from the peripheral input device and a digest associated
with the input data;
processing the received input data as standard input; and
verifying an origin of the standard input, the verifying including applying the signing certificate for the peripheral input device to the digest and checking contents of the digest against the standard input.

14. The computer program product of claim 13, wherein the input data is generated based on user input entered via the peripheral input device.

15. The computer program product of claim 14, wherein the peripheral input device is a keyboard and the user input is one or more keystrokes, and wherein the digest associated with the input data is produced based, at least in part, on operations comprising:
generating a scan code for a keystroke;
copying the scan code;
adding a salt to the copy of the scan code; and
signing the salted copy of the scan code to produce the digest.

16. The computer program product of claim 13, wherein the operations further comprise:
saving a file with verified origins of the standard input with a copy of the associated digests and a copy of the signing certificate; and
executing a verification of the origin of content included in the file by at least one of a program, an interface, or an application as part of displaying, processing, or manipulating the file.

17. A computer system for content origin verification, comprising:
a processor set;
one or more computer-readable storage media; and
program instructions stored on the one or more computer-readable storage media to cause the processor set to perform operations comprising:
obtaining a signing certificate for a peripheral input device;
receiving input data from the peripheral input device and a digest associated
with the input data;
processing the received input data as standard input; and
verifying an origin of the standard input, the verifying including applying the signing certificate for the peripheral input device to the digest and checking contents of the digest against the standard input.

18. The computer system of claim 17, wherein the input data is generated based on user input entered via the peripheral input device.

19. The computer system of claim 18, wherein the peripheral input device is a keyboard and the user input is one or more keystrokes, and wherein the digest associated with the input data is produced based, at least in part, on operations comprising:
generating a scan code for a keystroke;
copying the scan code;
adding a salt to the copy of the scan code; and
signing the salted copy of the scan code to produce the digest.

20. The computer system of claim 17, wherein the operations further comprise:
saving a file with verified origins of the standard input with a copy of the associated digests and a copy of the signing certificate; and
executing a verification of the origin of content included in the file by at least one of a program, an interface, or an application as part of displaying, processing, or manipulating the file.
